(19) United States
(12) Patent Application Publication
(10) Pub. No.: US 2026/0131719 A1
(43) Pub. Date: May 14, 2026

(54) LOADING STRAP TENSIONING DEVICES AND ADAPTERS THEREFOR.

(71) Applicant: Gabriel Tremblay, Sacré-Coeur (CA)

(72) Inventor: Gabriel Tremblay, Sacré-Coeur (CA)

(21) Appl. No.: 19/386,759

(22) Filed: Nov. 12, 2025

(30) Foreign Application Priority Data
Nov. 13, 2024 (GB) 2416737.1

(51) Int. Cl. B60P 7/08; B66D 1/04; B66D 1/12

(52) U.S. Cl. CPC B60P 7/0853; B66D 1/04; B66D 1/12

(57) ABSTRACT

An adapter kit for allowing use of a drill to operate a cargo strap tensioning winch having an axle around which a cargo strap is windable, the axle having a winch bar mount configured for removably mounting a winch bar thereto, the adapter kit comprising: a winch adapter securable to the winch bar mount, the winch adapter defining a winch adapter head axially aligned with the axle when the winch adapter is operatively secured to the winch bar mount; and a drill adapter mountable to the drill so as to be axially rotatable thereby, the drill adapter defining a drill adapter head removably mountable to the winch adapter head so as to be jointly axially rotatable therewith. Also a winch and a winch adapter.

### FIELD OF THE INVENTION

The present invention relates to the general field of cargo transportation, and more particularly to loading strap tensioning devices and to adapters usable with a loading strap tensioning device.

### BACKGROUND

Loading strap winches are used in the transportation industry to secure loads to platform trailers and trucks, among other uses. Due to the requirement of having to often secure large loads, many of them are operated using long levers called winch bars, that are used to turn the winch. In use, these winch bars are inserted in an aperture provided on the axle onto which the strap is wound and extending transversally relative thereto. Then, the winch bar is used to turn the axle, followed by removal from the aperture, and then inserted in another similar aperture, provided at a different circumferential location around the axle. This operation can be relatively long to perform, and still requires that relatively large forces be exerted manually on the winch bar.

Thus, there is a need on the market for an improved devices for tensioning loading straps.

An object of the present invention is to provide such an improved device.

### SUMMARY OF THE INVENTION

In a broad aspect, there is provided an adapter kit for allowing use of a drill to operate a cargo strap tensioning winch having an axle around which a cargo strap is windable, the axle having a winch bar mount configured for removably mounting a winch bar thereto, the adapter kit comprising: a winch adapter securable to the winch bar mount, the winch adapter defining a winch adapter head axially aligned with the axle when the winch adapter is operatively secured to the winch bar mount; and a drill adapter mountable to the drill so as to be axially rotatable thereby, the drill adapter defining a drill adapter head removably mountable to the winch adapter head so as to be jointly axially rotatable therewith.

There may also be provided an adapter kit wherein one of the winch adapter head and drill adapter head defines an adapter protrusion protruding axially therefrom and an other one of the winch adapter head and drill adapter head defines an axial adapter recess configured for receiving the adapter protrusion so that the winch adapter and drill adapter become axially jointly rotatable.

There may also be provided an adapter kit wherein the adapter protrusion and the adapter recess both have a substantially square transversal cross-sectional configuration.

There may also be provided an adapter kit wherein the winch adapter is weldable to the winch bar mount.

There may also be provided an adapter kit wherein the winch bar mount defines an axially extending winch bar mount recess, the winch adapter including a winch adapter mounting shaft insertable in the winch bar mount recess prior to welding.

There may also be provided an adapter kit wherein the winch bar mount defines a winch bar engaging bore extending perpendicular to and intersecting the winch bar mount recess, the winch adapter mounting shaft being configured and sized to clear the winch bar engaging bore.

There may also be provided an adapter kit wherein the winch adapter mounting shaft has a substantially hexagonal configuration and is weldable to the winch bar mount with the winch adapter mounting shaft pointing axially outwardly therefrom.

There may also be provided an adapter kit wherein the drill adapter head defines an adapter protrusion protruding axially therefrom and the winch adapter head defines an axial adapter recess configured for receiving the adapter protrusion so that the winch adapter and drill adapter are axially jointly rotatable and located axially opposed to the winch adapter mounting shaft.

There may also be provided an adapter kit wherein the winch bar mount defines an axially extending winch bar mount recess, the winch adapter including a winch adapter mounting shaft insertable in the winch bar mount recess, the adapter kit further comprising a lock for locking the winch adapter mounting shaft in the winch adapter mounting shaft.

There may also be provided an adapter kit wherein the winch bar mount defines a winch bar engaging bore extending perpendicular to and intersecting with the winch bar mount recess and wherein the winch adapter mounting shaft defines a mounting shaft bore extending diametrically therethrough and positionable in register with the winch bar engaging bore, the lock including a pin insertable through the mounting shaft bore and the winch bar engaging bore.

There may also be provided an adapter kit wherein the winch bar mount defines an axially extending winch bar mount recess and a winch bar engaging bore extending perpendicular to and intersecting with the winch bar mount recess, the winch adapter including a winch adapter mounting shaft insertable in the winch bar mount recess, the adapter kit further comprising a pin mountable in the winch bar engaging bore, the winch adapter being removably mountable to the winch bar mount with the pin mounted thereto so that the winch adapter engages the pin to allow joint rotation of the winch adapter and winch bar mount.

There may also be provided an adapter kit wherein the winch adapter defines a winch adapter mounting shaft extending from the winch adapter head and insertable in the winch bar mount, the winch adapter mounting shaft defining a mounting shaft recess extending axially thereinto opposed to the winch adapter head and configured for engaging the pin when inserted in the winch bar mount.

There may also be provided an adapter kit wherein the winch adapter further defines a sleeve extending from the winch adapter head concentric with the winch adapter mounting shaft and configured for receiving the winch bar mount thereinto while engaging the pin when the winch adapter is mounted to the winch bar mount.

There may also be provided an adapter kit wherein the pin defines a medial recessed portion of a diameter smaller than axially outwardly located portions of the pin, and wherein the sleeve defines sleeve recesses extending axially thereinto opposed to the winch adapter head, the sleeve recesses being wider than the mounting shaft recess.

In another broad aspect, there is provided a cargo strap tensioning winch comprising: a winch body; an axle mounted to the winch body so as to be axially rotatable, the axle having a winch bar mount configured for removably moving a winch bar thereto; a winch adapter secured to the winch bar mount, the winch adapter defining a winch adapter head axially aligned with the axle; and a drill adapter mountable to the drill so as to be axially rotatable thereby, the drill adapter defining a drill adapter head removably mountable to the winch adapter head so as to be jointly axially rotatable therewith.

The characteristics of the winch and drill adapters mentioned above also apply in the cargo strap tensioning winch.

In yet another broad aspect, there is provide a winch adapter mountable to a cargo strap tensioning winch having an axle around which a cargo strap is windable, the axle having a winch bar mount configured for removably mounting a winch bar thereto, the winch bar mount defining an axially extending winch bar mount recess and a winch bar engaging bore extending perpendicular to and intersecting with the winch bar mount recess, a pin being mounted to the winch bar mount through the winch bar engaging bore, the winch adapter comprising: a winch adapter head configured for engaging a rotation tool usable to rotate the winch adapter head; and a winch adapter mounting shaft insertable in the winch bar mount recess the winch adapter being removably mountable to the winch bar mount with the pin mounted thereto so that the winch adapter engages the pin to allow joint rotation of the winch adapter and winch bar mount through the rotation tool engaging the winch adapter head.

There may also be provided a winch adapter wherein the winch adapter mounting shaft defines a mounting shaft recess extending axially thereinto opposed to the winch adapter head and configured for engaging the pin when inserted in the winch bar mount.

There may also be provided a winch adapter wherein the winch adapter further defines a sleeve extending from the winch adapter head concentric with the winch adapter mounting shaft and configured for receiving the winch bar mount thereinto while engaging the pin when the winch adapter is mounted to the winch bar mount.

There may also be provided a winch adapter wherein the pin defines a medial recessed portion of a diameter smaller than axially outwardly located portions of the pin, and wherein the sleeve defines sleeve recesses extending axially thereinto opposed to the winch adapter head positioned for engaging a protruding portion of the pin protruding from the winch par mount, the sleeve recesses being wider than the mounting shaft recess.

Advantageously, proposed kit, winch and winch adapter allow use of a rotation tool, such as a ratchet wrench or drill, among others, to rapidly and efficiently tighten cargo straps while requiring minimal modifications to existing winches.

The present invention claims priority from UK patent application GB 2416737.1 filed Nov. 13, 2025, the contents of which is hereby incorporated by reference in its entirety.

Other objects, advantages and features of the present invention will become more apparent upon reading of the following non-restrictive description of some embodiments thereof, given by way of example only with reference to the accompanying drawings.

### BRIEF DESCRIPTION OF THE DRAWINGS

FIG. 1, in a perspective view, illustrates an embodiment of a cargo strap tensioning winch and an adapter kit;

FIG. 2, in a perspective view, illustrates a pin part of the adapter kit of FIG. 1;

FIG. 3, in a perspective view, illustrate an alternative pin;

FIG. 4, in a perspective view, illustrate another alternative pin;

FIG. 5, in a perspective view, illustrate yet another alternative pin;

FIG. 6, in a perspective view, illustrates a winch adapter part of the adapter kit of FIG. 1;

FIG. 7, in a side elevation view, illustrates the winch adapter of FIG. 6;

FIG. 8, in an alternative perspective view, illustrates the winch adapter of FIG. 6;

FIG. 9, in a perspective view, illustrates an alternative winch adapter;

FIG. 10, in a side elevation view, illustrates the winch adapter of FIG. 9;

FIG. 11, in an alternative perspective view, illustrates the winch adapter of FIG. 9;

FIG. 12, in a perspective view, illustrates another alternative winch adapter;

FIG. 13, in a side elevation view, illustrates the winch adapter of FIG. 12;

FIG. 14, in an alternative perspective view, illustrates the winch adapter of FIG. 12;

FIG. 15, in a perspective view, illustrates yet another alternative winch adapter;

FIG. 16, in a side elevation view, illustrates the winch adapter of FIG. 15;

FIG. 17, in an alternative perspective view, illustrates the winch adapter of FIG. 15;

FIG. 18, in a perspective view, illustrates yet another alternative adapter;

FIG. 19, in a side elevation view, illustrates the winch adapter of FIG. 18;

FIG. 20, in an alternative perspective view, illustrates the winch adapter of FIG. 18;

FIG. 21, in a perspective view, illustrates yet another alternative winch adapter;

FIG. 22, in a side elevation view, illustrates the winch adapter of FIG. 21;

FIG. 23, in an alternative perspective view, illustrates the winch adapter of FIG. 21;

FIG. 24, in a front elevation view, illustrates the winch adapter of FIG. 21;

FIG. 25, in a rear elevation view, illustrates the winch adapter of FIG. 21;

FIG. 26, in a top plan view, illustrates the winch adapter of FIG. 21;

FIG. 27, in a perspective view, illustrates the winch adapter of FIG. 21 engaged with the pin of FIG. 4;

FIG. 28, in a front elevation view with a cross-sectional view of a winch mount, illustrates a step in an example of use of the winch adapter of FIG. 21 engaged with the pin of FIG. 4;

FIG. 29, in a front elevation view with a cross-sectional view of a winch mount, illustrates another step in an example of use of the winch adapter of FIG. 21 engaged with the pin of FIG. 4;

FIG. 30, in a perspective view, illustrates a drill adapter part of the adapter kit of FIG. 1;

FIG. 31, in a perspective view, illustrates an alternative drill adapter part;

FIG. 32, in a perspective exploded view, illustrates the pin of FIG. 2 mounted to a winch and its use with the winch adapters of FIGS. 9 and 21;

FIG. 33, in a perspective exploded view, illustrates a winch and its use with the winch adapters of FIGS. 12 and 18;

FIG. 34, in a perspective exploded view, illustrates how the pin of FIG. 4 is mounted to a winch;

FIG. 35, in a perspective exploded view, illustrates how the pin of FIG. 5 is mounted to a winch;

FIG. 36, in a perspective exploded view, illustrates how the pin of FIG. 2 is mounted to a winch; and

FIG. 37, in a perspective exploded view, illustrates alternative methods of using the winch adapter of FIG. 21;

### DETAILED DESCRIPTION

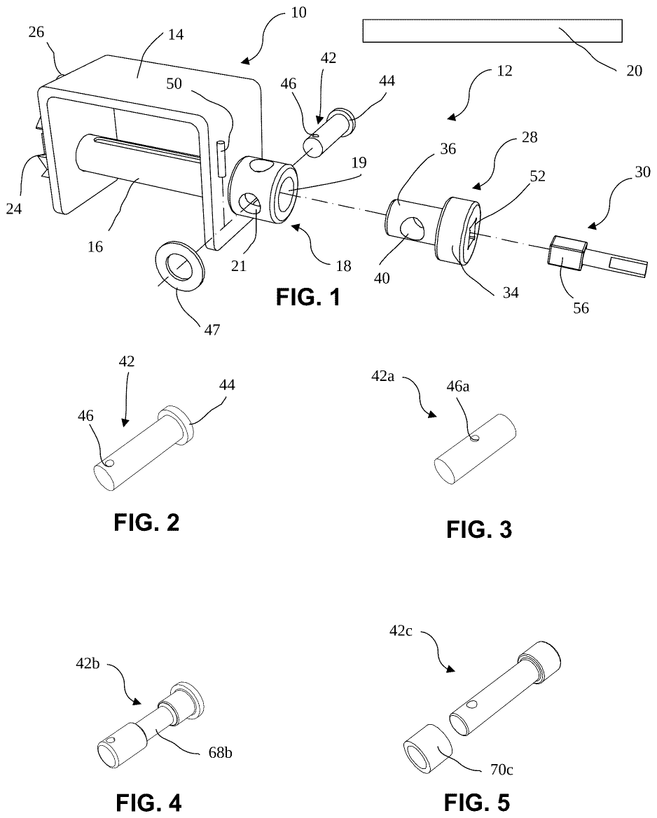

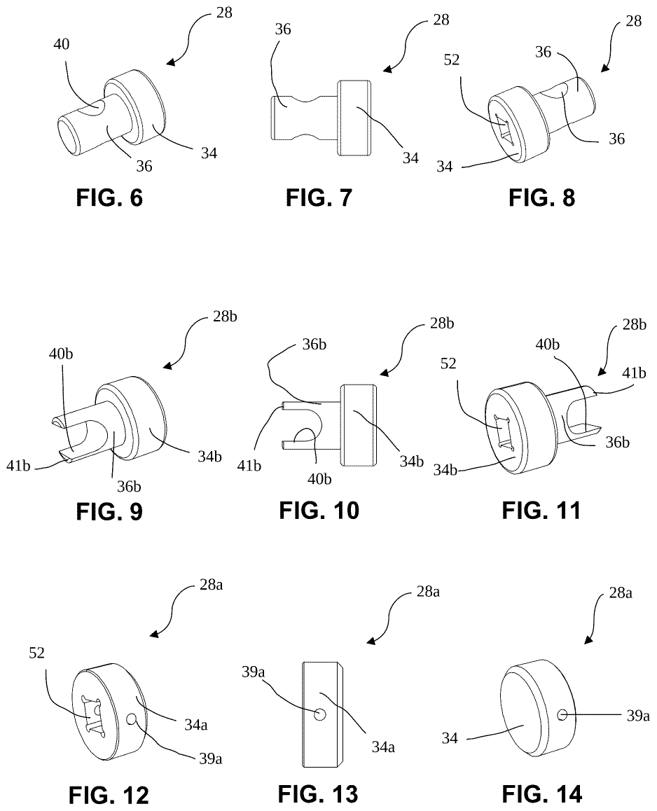

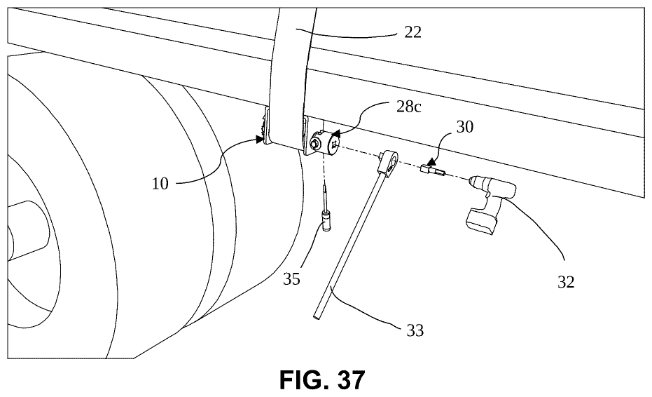

Referring to FIG. 1, there is shown a cargo strap tensioning winch 10 and an adapter kit 12. The cargo strap tensioning winch 10 includes a winch body 14 and an axle 16 mounted to the winch body 14 so as to be axially rotatable. The axle 16 is terminated at one end thereof by a winch bar mount 18 configured for removably moving a winch bar 20 (schematically illustrated in FIG. 1) thereto. For example, the winch body 14 has a substantially U-shaped configuration, receives the axle 16 thereacross, between the two legs of the U, and is typically secured at the periphery of a cargo platform 15, as seen in FIG. 37. The winch bar mount 18 is typically provided outside of the winch body 14. Still referring to FIG. 37, the cargo strap tensioning winch 10 is usable to roll a cargo strap 22 around the axle 16 and to exert tension thereof to secure a load (not shown in FIG. 37) to the cargo platform 15.

Returning to FIG. 1, the axle 16 is also typically terminated outside of the winch body 14 on the end of the axle 16 opposed to the winch bar mount 18 by a ratchet wheel 24 (only partially visible). A ratchet pawl 26 (only partially visible)is also provided adjacent the ratchet wheel 24 to maintain tension in the cargo strap 22 when the latter has been tightened. The ratchet wheel 24 and pawl 26 are conventional.

Typically, the winch bar mount 18 defines an axially extending winch bar mount recess 19 and at least one a winch bar engaging bore 21 extending through the winch bar mount 18 perpendicular to and intersecting the winch bar mount recess 19. The winch bar engaging bore 21 typically extends across the whole diameter of the winch bar mount 18. Also, in some embodiments, two orthogonal winch bar engaging bores 21 are provided. It should be noted that in some embodiments, one or both of the winch bar mount recess 19 and winch bar engaging bore 21 are omitted. The specific configuration of the winch adapter 28 is selected according to the configuration of the winch bar mount 18 to which it must be secured.

The adapter kit 12 includes a winch adapter 28 and a drill adapter 30. The winch adapter 28 is securable to the winch bar mount 18. The drill adapter 30 is mountable to a drill 32 (seen in FIG. 37) so as to be axially rotatable thereby. In other embodiments, a ratchet wrench 33 is used instead of the drill 32, in which case the drill adapter 30 may be omitted. The drill adapter 30 is configured to engage the winch adapter 28 so as to be jointly rotatable therewith. Therefore, with the winch adapter 28 secured to the winch bar mount 18 and the drill adapter 30 engaged with the winch adapter 28, the drill 32 can be used to tighten the cargo strap 22, without using the winch bar 20. In some embodiments, the whole tightening process is performed using the drill 32. In other embodiments, the cargo strap 22 is first tightened with the drill 32, and then the winch bar 20, or a long ratchet wrench 33, is used to completely tighten the cargo strap 22. In some embodiments a geared drill can be used, so that relatively large torques can be exerted on the axle 16. In some embodiments, a screwdriver 35 can be used to tighten the cargo strap tensioning winch 10, for example if only a few ratchet clicks are needed and the cargo strap 22 is not under a large tension.

In the embodiment shown in FIG. 1, the winch adapter 28 includes a winch adapter head 34 axially aligned with the axle 16 when the winch adapter 28 is operatively secured to the winch bar mount 18. The winch adapter 28 also includes a winch adapter mounting shaft 36 insertable in the winch bar mount recess 19.

In some embodiments, the winch adapter 28 is secured to the winch bar mount 18 through welding. In other embodiments, the winch adapter 28 is locked to the winch bar mount using a lock, which more specifically locks the winch adapter mounting shaft 36 in the winch bar mount recess 19. For example, the winch adapter mounting shaft 36 defines a mounting shaft bore 40 extending diametrically therethrough and positionable in register with the winch bar engaging bore 21. Also, the lock includes a pin 42 insertable through the mounting shaft bore 40 and the winch bar engaging bore 21, therefore locking the winch adapter 28 in place. The pin 42 may define a pin head 44 protruding radially outwardly therefrom at one end thereof and a pin bore 46 extending diametrically therethrough at the opposed end for receiving a locking pin 50 therethrough so that the latter protrudes from the pin 42. The pin head 44 and locking pin 50 therefore prevent accidental removal of the pin 42, which ensures secure attachment of the winch adapter 28 is secured to the winch bar mount 18. In some embodiments, a washer 47 is slid on the pin 42 between the pin 42 and the winch bar mount 18.

The winch adapter head 34 defines an adapter recess 52 extending axially thereinto. The drill adapter 30 is configured to be substantially snugly received in the adapter recess 52 for joint rotation therewith.

Referring collectively to FIG. 30, the drill adapter 30 includes a drill adapter head 56, a drill adapter shaft 58 extending therefrom and terminated by a drill adapter mount 60 mountable to the drill 32. The drill adapter head 56 forms an adapter protrusion that is configured to engage the adapter recess 52. For example, the adapter protrusion and the adapter recess 52 both have a substantially square transversal cross-sectional configuration, but other configurations are within the scope of the invention, such as hexagonal configurations non-limitingly. It should be noted that in alternative embodiments, the drill adapter 30 defines the recess and the winch adapter 28 defines the protrusion. The drill adapter mount 60 has for example a generally triangular transversal cross-sectional configuration with substantially flat faces 62 positioned to engage a conventional chuck of the drill 32.

A seen in FIG. 31, in alternative embodiments, the head 56a of the drill adapter 30a is provided with a recess 57a extending laterally thereinto, and usable for example with the winch adapter 28a of FIGS. 12 to 14. The winch adapter 28a is similar to the winch adapter 28, except that in the winch adapter 28a, the winch adapter mounting shaft 36 is omitted. The winch adapter 28a is intended to be welded to the winch bar mount 18. Also, the winch adapter 28a includes a lateral aperture 39a extending laterally thereinto to the adapter recess 52 and positioned for alignment with the recess 57, so that a lock pin 59 is insertable through both, as illustrated in FIG. 33.

FIGS. 9 to 11 illustrate yet another winch adapter 28b similar to the winch adapter 28, except that the winch adapter 28b has a different winch adapter mounting shaft 36b that is configured and sized to clear the winch bar engaging bore 21 to allow insertion of the winch bar 20 therethrough with the winch adapter 28b welded to the winch bar mount 18. For example, instead of defining a mounting shaft bore 40, the winch adapter mounting shaft 36b defines a diametrically U-shaped passageway 40b extending thereinto at its free end 41b. In such embodiments, the winch adapter 28b is also temporarily insertable in the winch bar mount 18 to engage the pin 42, without welding, as the passageway 40b can engage the pin 42 while allowing easy removal of the winch adapter 28b from the adapter mounting shaft 36b.

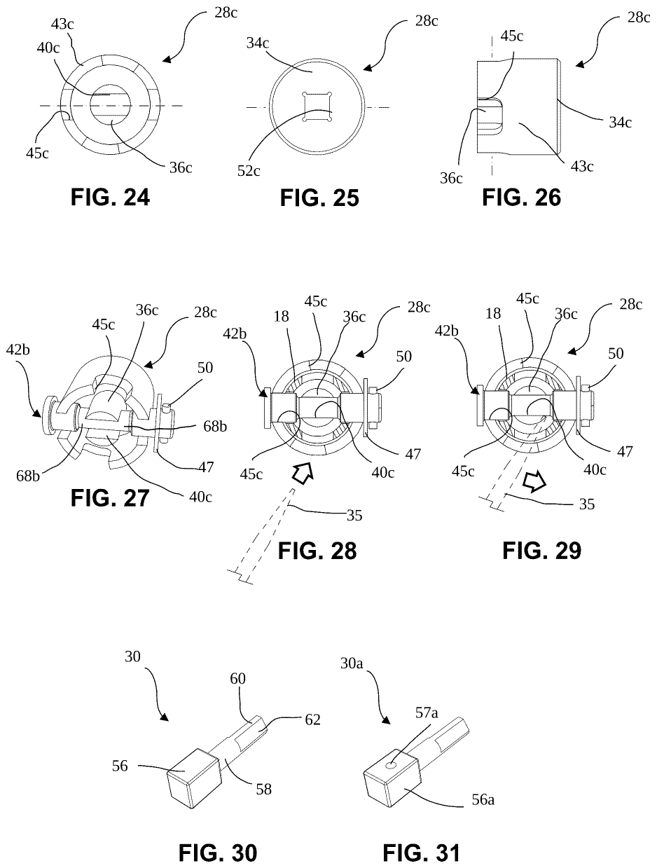

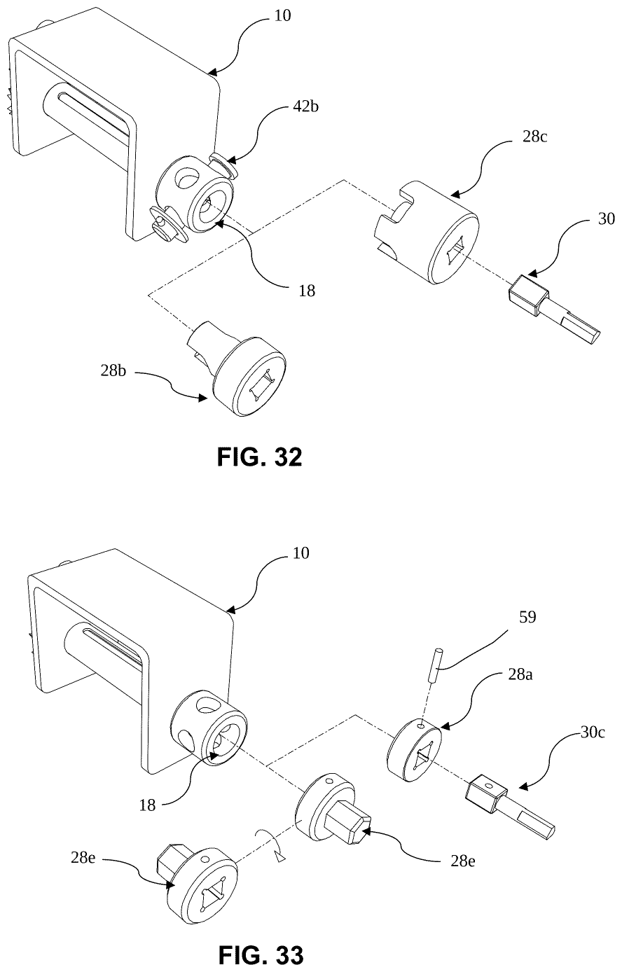

FIGS. 21 to 26 illustrate yet another winch adapter 28c similar to the winch adapter 28b, except that the winch adapter 28c includes a sleeve 43c concentric with the winch adapter mounting shaft 36c (which is similar to the winch adapter mounting shaft 36b). The sleeve 43c defines U-shaped recesses 45c extending thereinto from its free end 51c. At least two diametrically opposed recesses 45c are defined. In some embodiments, two additional recesses 45c are defined, offset by about 90 degrees relative to the other two. The recesses 45c are wider than the recess 40c of the winch adapter mounting shaft 36c. The winch adapter 28c is usable with the pin 42 or the pin 42b of FIG. 4. The pin 42b includes a two-tier pin shaft, with a recessed medial portion 68b. Otherwise, the pin 42b is similar to the pin 42.

The winch adapter 28c, pin 42 and pin 42b together form a kit usable with different types of winch mounts 18. Indeed, winch mounts 18 of two different diameters are common in the industry, which will be referred to as small and large winch mounts 18 hereinbelow. Similarly, the winch bar engaging bores 21 are also found in two typical sizes, referred below as the small and large winch bar engaging bores 21. The small and large winch bar engaging bores 21 can be found on either the small or large winch mounts 18.

When the winch adapter 28c is mounted to the small winch mounts 18, the sleeve 43c is outside of the winch mount 18, and the winch adapter mounting shaft 36c is inside the winch mount 18, as seen in FIGS. 25 and 26. When the winch adapter 28c is mounted to the large winch mounts 18, the sleeve 43c is inserted in the winch mount 18 (not shown in the drawings), similarly to the way the winch adapter mounting shaft 36b is inside the winch mount 18.

The pin 42 is usable with the small winch bar engaging bores 21, in which case the recess 40b is engaged by the pin 42 when the winch adapter 28c is mounted to the winch mounts 18, similarly to the way the winch adapter 42b is used. The pin 42b is usable with the large winch bar engaging bores 21. In these embodiments, as seen in FIGS. 25 and 26, the recessed portion 68b engages the recess 40c, while the larger portions of of the pin 42b engage the winch bar mounting bores 21 and the recesses 45c.

Advantageously, when 4 recesses 45c are provided, the two unoccupied recesses 45c can be used to insert thereinto the tip of a screwdriver 35, which can be used to turn the winch 10, as seen in FIGS. 28 and 29.

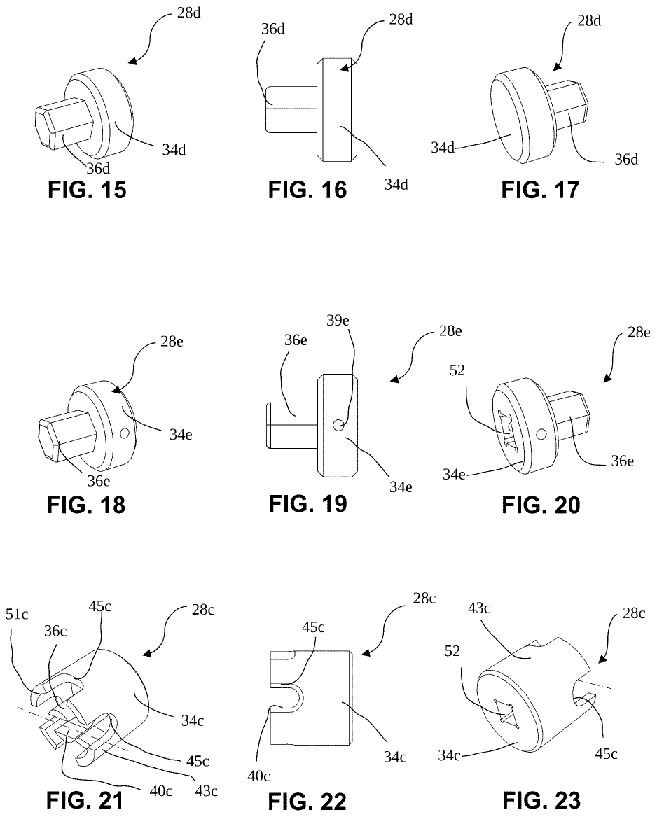

FIGS. 15 to 17 illustrate yet another winch adapter 28d similar to the winch adapter 28a, except that its winch adapter mounting shaft 36d has a substantially hexagonal configuration and the winch adapter 28d is weldable to the winch bar mount 18 with the winch adapter mounting shaft 28d pointing axially outwardly therefrom. In this configuration, the winch adapter 28d is usable using a conventional hexagonal head mounted to the drill 32. Alternatively, the same winch adapter 28d can be welded with the winch adapter mounting shaft 36d inside the winch bar mount 18. This provides versatility in the type of tool usable to operate the winch 10.

FIGS. 18 to 20 illustrate yet another winch adapter 28e similar to the winch adapter 28d, except that the lateral aperture 39c is provided in its head 34e for use with the lock pin 59, similarly to what has been described above.

The pin 42c shown in FIG. 5 is similar to the pin 42, but it also includes a sleeve 70c slidable thereon. The pin 42c is convenient to mount thereto a winch adapter 36b configured for use with large winch bar engaging bores 21 on a winch 10 having small winch bar engaging bores 21, so that a small pin 42 can be used to mount to the winch 10 while the sleeve 70c allows engagement with a wider recess 40b.

The pin 42a is similar to the pin 42, except that the head 44 is omitted and the locking aperture 46a is provided in the middle of the pin 42. When a locking pin 50 is inserted in the locking aperture 46a with the pin 42a inserted through the winch bar mount 18, the pin 42 is prevented from exiting the winch bar mount if is it too long to exit through the winch bar engaging bores 21.

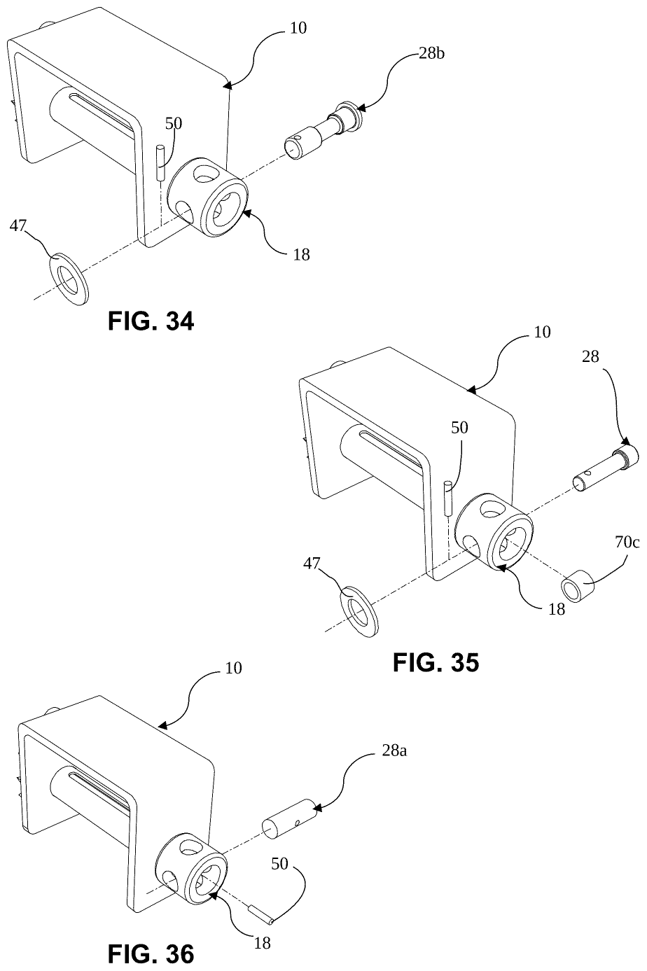

Use of the pins 42b, 42c and 42a is shown respectively in FIGS. 34, 35 and 36.

Although the present invention has been described hereinabove by way of exemplary embodiments thereof, it will be readily appreciated that many modifications are possible in the exemplary embodiments without materially departing from the novel teachings and advantages of this invention. Accordingly, the scope of the claims should not be limited by the exemplary embodiments, but should be given the broadest interpretation consistent with the description as a whole. The present invention can thus be modified without departing from the spirit and nature of the subject invention as defined in the appended claims.

What is claimed is

1. An adapter kit for allowing use of a drill to operate a cargo strap tensioning winch having an axle around which a cargo strap is windable, the axle having a winch bar mount configured for removably mounting a winch bar thereto, the adapter kit comprising:
a winch adapter securable to the winch bar mount, the winch adapter defining a winch adapter head axially aligned with the axle when the winch adapter is operatively secured to the winch bar mount; and
a drill adapter mountable to the drill so as to be axially rotatable thereby, the drill adapter defining a drill adapter head removably mountable to the winch adapter head so as to be jointly axially rotatable therewith.

2. The adapter kit as defined in claim 1, wherein one of the winch adapter head and drill adapter head defines an adapter protrusion protruding axially therefrom and an other one of the winch adapter head and drill adapter head defines an axial adapter recess configured for receiving the adapter protrusion so that the winch adapter and drill adapter become axially jointly rotatable.

3. The adapter kit as defined in claim 2, wherein the adapter protrusion and the adapter recess both have a substantially square transversal cross-sectional configuration.

4. The adapter kit as defined in claim 1, wherein the winch adapter is weldable to the winch bar mount.

5. The adapter kit as defined in claim 4, wherein the winch bar mount defines an axially extending winch bar mount recess, the winch adapter including a winch adapter mounting shaft insertable in the winch bar mount recess prior to welding.

6. The adapter kit as defined in claim 4, wherein the winch bar mount defines a winch bar engaging bore extending perpendicular to and intersecting the winch bar mount recess, the winch adapter mounting shaft being configured and sized to clear the winch bar engaging bore.

7. The adapter kit as defined in claim 5, wherein the winch adapter mounting shaft has a substantially hexagonal configuration and is weldable to the winch bar mount with the winch adapter mounting shaft pointing axially outwardly therefrom.

8. The adapter kit as defined in claim 7, wherein the drill adapter head defines an adapter protrusion protruding axially therefrom and the winch adapter head defines an axial adapter recess configured for receiving the adapter protrusion so that the winch adapter and drill adapter are axially jointly rotatable and located axially opposed to the winch adapter mounting shaft.

9. The adapter kit as defined in claim 1, wherein the winch bar mount defines an axially extending winch bar mount recess, the winch adapter including a winch adapter mounting shaft insertable in the winch bar mount recess, the adapter kit further comprising a lock for locking the winch adapter mounting shaft in the winch adapter mounting shaft.

10. The adapter kit as defined in claim 9, wherein the winch bar mount defines a winch bar engaging bore extending perpendicular to and intersecting with the winch bar mount recess and wherein the winch adapter mounting shaft defines a mounting shaft bore extending diametrically therethrough and positionable in register with the winch bar engaging bore, the lock including a pin insertable through the mounting shaft bore and the winch bar engaging bore.

11. The adapter kit as defined in claim 1, wherein the winch bar mount defines an axially extending winch bar mount recess and a winch bar engaging bore extending perpendicular to and intersecting with the winch bar mount recess, the winch adapter including a winch adapter mounting shaft insertable in the winch bar mount recess, the adapter kit further comprising a pin mountable in the winch bar engaging bore, the winch adapter being removably mountable to the winch bar mount with the pin mounted thereto so that the winch adapter engages the pin to allow joint rotation of the winch adapter and winch bar mount.

12. The adapter kit as defined in claim 11, wherein the winch adapter defines a winch adapter mounting shaft extending from the winch adapter head and insertable in the winch bar mount, the winch adapter mounting shaft defining a mounting shaft recess extending axially thereinto opposed to the winch adapter head and configured for engaging the pin when inserted in the winch bar mount.

13. The adapter kit as defined in claim 12, wherein the winch adapter further defines a sleeve extending from the winch adapter head concentric with the winch adapter mounting shaft and configured for receiving the winch bar mount thereinto while engaging the pin when the winch adapter is mounted to the winch bar mount.

14. The adapter kit as defined in claim 13, wherein the pin defines a medial recessed portion of a diameter smaller than axially outwardly located portions of the pin, and wherein the sleeve defines sleeve recesses extending axially thereinto opposed to the winch adapter head, the sleeve recesses being wider than the mounting shaft recess.

15. A cargo strap tensioning winch comprising:
a winch body;
an axle mounted to the winch body so as to be axially rotatable, the axle having a winch bar mount configured for removably moving a winch bar thereto;
a winch adapter secured to the winch bar mount, the winch adapter defining a winch adapter head axially aligned with the axle; and
a drill adapter mountable to the drill so as to be axially rotatable thereby, the drill adapter defining a drill adapter head removably mountable to the winch adapter head so as to be jointly axially rotatable therewith.

16. A winch adapter mountable to a cargo strap tensioning winch having an axle around which a cargo strap is windable, the axle having a winch bar mount configured for removably mounting a winch bar thereto, the winch bar mount defining an axially extending winch bar mount recess and a winch bar engaging bore extending perpendicular to and intersecting with the winch bar mount recess, a pin being mounted to the winch bar mount through the winch bar engaging bore, the winch adapter comprising:
a winch adapter head configured for engaging a rotation tool usable to rotate the winch adapter head; and
a winch adapter mounting shaft insertable in the winch bar mount recess the winch adapter being removably mountable to the winch bar mount with the pin mounted thereto so that the winch adapter engages the pin to allow joint rotation of the winch adapter and winch bar mount through the rotation tool engaging the winch adapter head.

17. The winch adapter as defined in claim 16, wherein the winch adapter mounting shaft defines a mounting shaft recess extending axially thereinto opposed to the winch adapter head and configured for engaging the pin when inserted in the winch bar mount.

18. The winch adapter as defined in claim 17, wherein the winch adapter further defines a sleeve extending from the winch adapter head concentric with the winch adapter mounting shaft and configured for receiving the winch bar mount thereinto while engaging the pin when the winch adapter is mounted to the winch bar mount.

19. The winch adapter as defined in claim 18, wherein the pin defines a medial recessed portion of a diameter smaller than axially outwardly located portions of the pin, and wherein the sleeve defines sleeve recesses extending axially thereinto opposed to the winch adapter head positioned for engaging a protruding portion of the pin protruding from the winch par mount, the sleeve recesses being wider than the mounting shaft recess.
